(19) United States
(12) Patent Application Publication
(10) Pub. No.: US 2026/0134233 A1
(43) Pub. Date: May 14, 2026

(54) FRAMEWORK SELECTION FOR TASK EXECUTION

(71) Applicant: Infosys Limited, Bangalore (IN)

(72) Inventors: Sebastian WESTON LEWIS, London (GB); Prabhat Naramdeo, London (GB); Himanshu Gupta, Chandigarh (IN)

(73) Assignee: Infosys Limited, Bangalore (IN)

(21) Appl. No.: 19/078,832

(22) Filed: Mar. 13, 2025

(30) Foreign Application Priority Data
Nov. 12, 2024 (IN) 202441087194

(51) Int. Cl. G06F 40/58; G06F 11/34

(52) U.S. Cl. CPC G06F 40/58; G06F 11/3447

(57) ABSTRACT

A system for framework selection for task execution is provided. Framework records of various frameworks are analyzed and based on the analysis, a translation instruction set is generated for each framework to translate an operation from a predefined format to a format associated with the corresponding framework. The most suitable framework is determined for a particular operation. A mapping between various operations and the most suitable framework for each operation is generated. During task execution, multiple natural-language tasks are derived from a natural-language task description. Each natural-language task is translated into a neo-syntax operation. Based on the mapping, a suitable framework is selected for the execution of each neo-syntax operation. The operations are translated to the syntax of the suitable frameworks by using the corresponding translation instruction set. A task output for the natural-language task description is generated based on the execution of the translated operations.

### FIELD OF THE DISCLOSURE

Various embodiments of the present disclosure relate generally to task execution. More specifically, various embodiments of the present disclosure relate to framework selection for task execution.

### BACKGROUND

In recent years, Artificial Intelligence (AI) has emerged as a powerful tool for solving complex real-world problems across various domains, such as healthcare, finance, traffic management, urban planning, manufacturing, or the like. These problems may be critical, and hence, accurate and efficient execution of these problems may be paramount. Various AI frameworks are available to enable accurate and efficient execution of these problems. Typically, each problem or task can be broken down into numerous complex sub-tasks, with each sub-task executed independently. Traditionally, a single AI framework may be selected to solve any real-world problem. In other words, the same AI framework may be utilized for executing all sub-tasks. These sub-tasks may encompass different technical capabilities, and utilizing the same AI framework for all sub-tasks may not be the most effective and accurate solution.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for framework selection for task execution are provided substantially as shown in, and described in connection with, at least one of the figures.

The systems disclosed herein include processing circuitry configured to convert a natural-language task description into a plurality of operations having a predefined syntax. Further, the processing circuitry may be configured to select, for each operation of the plurality of operations, a framework associated with an execution of the corresponding operation. The processing circuitry may be further configured to translate the plurality of operations. Each operation may be translated from the predefined syntax to a syntax of the associated framework. Further, the processing circuitry may be configured to execute the translated plurality of operations. Each translated operation, of the translated plurality of operations, may be executed based on the associated framework.

In some embodiments, the processing circuitry may convert the natural-language task description into the plurality of operations using natural language processing.

In some embodiments, to convert the natural-language task description into the plurality of operations having the predefined syntax, the processing circuitry may be further configured to derive a plurality of natural-language tasks from the natural-language task description and translate each natural-language task, of the plurality of natural-language tasks, to an operation, of the plurality of operations, having the predefined syntax.

In some embodiments, the natural-language task description may correspond to a user-defined prompt.

In some embodiments, the processing circuitry may be further configured to receive a user-defined prompt and generate, using a large language model, the natural-language task description based on the user-defined prompt.

In some embodiments, the system may further include a storage element. The storage element may be configured to store a database. The database may include a mapping between the plurality of operations and a plurality of frameworks such that a target framework, of the plurality of frameworks, may be mapped to each operation of the plurality of operations.

In some embodiments, the framework selected for executing each operation of the plurality of operations may correspond to the target framework mapped to the corresponding operation.

In some embodiments, the system may further include a storage element. The storage element may be configured to store a database. The database may include a mapping between the plurality of operations and a plurality of frameworks such that each operation has, mapped thereto, one or more frameworks, of the plurality of frameworks, and one or more ratings assigned to the one or more frameworks, respectively. Each of the one or more ratings may be indicative of a degree of suitability of the corresponding framework for executing the corresponding operation.

In some embodiments, the framework selected for executing each operation of the plurality of operations may have the highest rating among the one or more frameworks mapped to the corresponding operation.

In some embodiments, the translated plurality of operations may be executed concurrently or sequentially.

In some embodiments, the processing circuitry may be further configured to generate a task output based on the execution of the translated plurality of operations.

In some embodiments, the processing circuitry may be further configured to present the task output on a user device associated with the system.

In some embodiments, the processing circuitry may be further configured to receive one or more triggers. The processing circuitry may translate the plurality of operations in response to the one or more triggers.

In some embodiments, the one or more triggers may correspond to one of a group consisting of a user input, lapse of a periodic time interval, or occurrence of a predetermined event.

In some embodiments, the processing circuitry may translate each operation of the plurality of operations from the predefined syntax to the syntax associated with the corresponding framework using a translation instruction set generated for the corresponding framework.

In some embodiments, the processing circuitry may execute each translated operation of the translated plurality of operations using an execution model associated with the corresponding framework.

In some embodiments, a method is disclosed. The method comprises converting, by processing circuitry, a natural-language task description into a plurality of operations having a predefined syntax. The method further comprises selecting, by the processing circuitry, for each operation of the plurality of operations, a framework associated with an execution of the corresponding operation. Further, the method comprises translating, by the processing circuitry, the plurality of operations, with each operation being translated from the predefined syntax to a syntax of the associated framework and executing, by the processing circuitry, the translated plurality of operations. Each translated operation, of the translated plurality of operations, is executed based on the associated framework.

In some embodiments, the processing circuitry may be configured to determine, for each framework of a plurality of frameworks, a plurality of features. The plurality of features may comprise a syntax and a set of functional characteristics of the corresponding framework. Further, the processing circuitry may be configured to generate a translation instruction set for each framework of the plurality of frameworks based on the plurality of features of the corresponding framework. The processing circuitry may be further configured to map the plurality of frameworks to a plurality of operations such that for a first operation, a target framework is mapped. At least one of the set of functional characteristics of the target framework matches the first operation. The translation instruction set of the target framework may be configured to translate the first operation from a predefined syntax to the syntax of the target framework.

In some embodiments, the processing circuitry may be further configured to analyze a plurality of framework records associated with each framework of the plurality of frameworks. The plurality of features for each framework of the plurality of frameworks may be determined based on the analysis of the plurality of framework records associated with the corresponding framework.

In some embodiments, the processing circuitry may be further configured to receive one or more triggers. The processing circuitry may analyze the plurality of framework records associated with each framework of the plurality of frameworks in response to the one or more triggers.

In some embodiments, the one or more triggers may correspond to at least one of a group consisting of a user input or occurrence of a predetermined event.

In some embodiments, the processing circuitry may be further configured to identify, from the plurality of frameworks, one or more frameworks associated with the first operation. At least one of the set of functional characteristics of each of the one or more frameworks matches the first operation. The processing circuitry may be further configured to execute the first operation based on each of the one or more frameworks and obtain a set of performance metrics for each framework of the one or more frameworks based on the execution of the first operation for the corresponding framework. The processing circuitry may be further configured to generate one or more ratings for the one or more frameworks, respectively, based on the set of performance metrics obtained for each framework of the one or more frameworks. The target framework for the first operation may be selected from the one or more frameworks based on the one or more ratings.

In some embodiments, the processing circuitry may be further configured to receive one or more triggers. The processing circuitry may identify the one or more frameworks associated with the first operation in response to the one or more triggers.

In some embodiments, the one or more triggers may correspond to at least one of a group consisting of a user input, a lapse of a periodic time interval, an update to at least one of the plurality of frameworks, or detection of a new framework.

In some embodiments, the target framework may have the highest rating among the one or more frameworks.

In some embodiments, to generate a rating, of the one or more ratings, for each framework of the one or more frameworks, the processing circuitry may be further configured to execute a plurality of measurement models on the set of performance metrics for the corresponding framework. Further, the processing circuitry may be configured to generate a plurality of scores for the corresponding framework based on the execution of the plurality of measurement models on the set of performance metrics. The rating may be generated based on the plurality of scores.

In some embodiments, the rating generated for each framework of the one or more frameworks may correspond to an aggregation of the plurality of scores associated with the corresponding framework.

In some embodiments, the plurality of measurement models may comprise at least two of a group consisting of a representation learning model, a deep Q-network model, or a policy gradient model.

In some embodiments, the set of functional characteristics of each framework of the plurality of frameworks may correspond to a set of operations supported by the corresponding framework.

In some embodiments, the system may further include a storage element. The processing circuitry may be coupled to the storage element. The processing circuitry may be configured to store a database including a mapping between the plurality of operations and the plurality of frameworks in the storage element.

In some embodiments, the system may further include a storage element. The processing circuitry may be coupled to the storage element. The processing circuitry may be configured to store a database including the translation instruction set for each framework of the plurality of frameworks.

In some embodiments, the processing circuitry may be further configured to determine whether at least one framework of the plurality of frameworks is updated. The processing circuitry may be configured to update, based on the determination that the at least one framework is updated, the plurality of features of the at least one framework. Further, processing circuitry may be configured to update the translation instruction set associated with the at least one framework based on the updated plurality of features.

In some embodiments, the update of the at least one framework corresponds to changes in a plurality of framework records associated with the at least one framework.

In some embodiments, the processing circuitry may be further configured to update, based on the updated plurality of features, a rating associated with the at least one framework.

In some embodiments, the processing circuitry may be further configured to identify, from the plurality of frameworks, one or more frameworks associated with the first operation. At least one of the set of functional characteristics of each of the one or more frameworks matches the first operation. The processing circuitry may be further configured to generate one or more ratings for the one or more frameworks, respectively. The target framework for the first operation may selected from the one or more frameworks based on the one or more ratings. The processing circuitry may be further configured to determine whether at least one framework of the one or more frameworks is updated. Further, the processing circuitry may be configured to update, based on the determination that the at least one framework is updated, a rating, of the one or more ratings, associated with the at least one framework. Further, the processing circuitry may be configured to determine whether the updated rating is higher than a rating associated with the target framework. The processing circuitry may be further configured to map, based on the determination that the updated rating is higher than the rating associated with the target framework, the updated framework as the target framework for the first operation.

In some embodiments, a method is disclosed. The method comprises determining, by processing circuitry, for each framework of a plurality of frameworks, a plurality of features comprising a syntax and a set of functional characteristics of the corresponding framework. The method further comprises generating, by the processing circuitry, a translation instruction set for each framework of the plurality of frameworks based on the plurality of features of the corresponding framework. Further, the method comprises mapping, by the processing circuitry, the plurality of frameworks to a plurality of operations such that for a first operation, a target framework is mapped. At least one of the set of functional characteristics of the target framework matches the first operation. Further, based on the translation instruction set of the target framework, the first operation is translated from a predefined syntax to the syntax of the target framework.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 illustrates an environment of framework selection for task execution, consistent with disclosed embodiments of the present disclosure;

FIG. 2 is a block diagram of a design controller of the environment of FIG. 1, consistent with disclosed embodiments of the present disclosure;

FIG. 3 is a block diagram of an execution controller of the environment of FIG. 1, consistent with disclosed embodiments of the present disclosure;

FIG. 4 shows an example computing system for carrying out the methods of the present disclosure, consistent with disclosed embodiments of the present disclosure;

FIGS. 5A and 5B, collectively, represents a flowchart that illustrates a method for framework selection for task execution during run time implementation, consistent with disclosed embodiments of the present disclosure; and

FIGS. 6A-6C, collectively, represents a flowchart that illustrates a method for framework selection for task execution during design time implementation, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, instead of using a single Artificial Intelligence (AI) framework for solving a real-world problem or task, different AI frameworks may be utilized for solving different sub-tasks of the real-world problem. A framework is a set of common functionalities that can be reused in solving various problems. In other words, a framework may streamline common tasks. Further, a framework may have certain key components associated therewith. For example, a framework may have a core library that may contain essential functions and classes for handling foundational tasks that are different from the framework's primary operations. For example, Django, a web development framework, may provide libraries for hypertext transfer protocol (HTTP) request handling, authentication, database management, or the like. A framework may also have built-in tools and utilities. For example, Django's manage.py utility may offer commands for database migrations, running the server, or the like, to allow application building, maintaining, and scaling. Further, the frameworks may offer configuration files to streamline application initialization and setup. For example, in Django, settings files may control execution configuration, database connections, or the like, that may help in managing different environments like development, testing, and production. Notably, each framework may provide a different problem-solving approach depending on the problem type, data availability, or the like. Thus, for an efficient and accurate task execution, determination of a suitable framework for each sub-task may be important.

Typically, a process of framework selection may be human-driven. Human dependency may render this process inefficient and often inaccurate. For example, it may not be feasible for a human to be aware of all the available frameworks as well as updates to the existing frameworks. Additionally, selection errors are likely in such human-dependent scenarios. Further, such a selection requires technical skills and may not be beneficial for all groups of people. Moreover, each sub-task may be in a format that is different from the format of the framework that is being utilized for its resolution. Therefore, upon selection of a framework associated with the sub-task, each sub-task may have to be translated from its format to a format that is compatible with the selected framework. Typically, the aforementioned translation may be carried out manually. This approach may hinder the ease-of-use and can be time-consuming. Further, it may not be feasible for a human to be well-versed in the structural aspect of all the available frameworks. This may further hinder the process of translation, thereby delaying the task execution.

The present disclosure provides a different approach to framework selection for task execution. In the present disclosure, framework records of various available frameworks may be analyzed. The framework records of a framework may include structural and functional information associated with the framework. The structural information may represent the framework's architecture. The structural information may include various components such as data structures, databases, templates, or the like. For example, Django may include various data structures such as dictionaries, arrays, trees, or the like, to store and manage data efficiently. Django may have default databases such as SQLite for storing data or may work with other databases such as PostgreSQL, MySQL, or the like. The templates may manage how the data is displayed to users by utilizing various programming languages such as Hypertext markup language (HTML), Cascading style sheets (CSS), JavaScript, or the like. Further, the functional information of the framework may define the behavior and actions within the framework. For example, Django provides built-in authentication features that can check if a user has provided the correct credentials and log them in the system if they are valid. Further, the functional information may also comprise logic for handling errors.

The analysis of the framework records of a framework may lead to the determination of one or more features associated with the framework. The determined features may include a syntax and functional characteristics associated with the framework. Further, a translation instruction set may be generated for each framework. The translation instruction set may translate an operation, matching at least one functional characteristic of a framework, from a predefined format to a format associated with the framework. All the frameworks are then tested to determine the most suitable framework for a particular operation. The testing can be implemented by using all relevant frameworks for executing the same operation and obtaining performance metrics for each execution. Based on the testing, a target framework is determined for each operation, and a mapping between various operations and the most suitable framework for each operation may be stored for use during task execution.

During task execution, the input may correspond to a natural-language task description of a real-world problem. The natural-language task description may be converted to multiple operations having the predefined syntax. Further, based on the mapping, a suitable framework may be determined for each converted operation, and the operation may be translated from the predefined syntax to a syntax associated with the suitable framework. The translation instruction set generated for the suitable framework may be utilized for the translation. Further, the translated operations may be executed based on the corresponding frameworks to generate a task output for the natural-language task description.

The present disclosure may thus allow for efficient task execution by automated performance-based framework selection. A suitable framework is determined for a task based on the operational efficiency of the framework for the corresponding task. Consequently, the performance efficiency of the task may be significantly improved. Determination of the suitable framework may be sans any human intervention. Therefore, human errors may also be avoided, leading to a further increase in performance. As the present disclosure executes a real-time and effective framework selection process, the need for a human to be aware of all the available frameworks as well as updates to the existing frameworks can be mitigated. Additionally, excessive translation time introduced due to manual translation may be significantly reduced due to real-time translation by utilization of translation instruction sets. Notably, technical skills may not be required for task execution, therefore the solution provided by the present disclosure may be leveraged by all groups of people. For example, the present disclosure requires only a natural-language description of the problem, which can be provided by a person with modest or no technical skills. The application area of the present disclosure may include any domain that utilizes various frameworks for its execution such as healthcare, traffic management, urban planning, or the like. It is appreciated that the human mind is not equipped to determine the most suitable framework, among an exhaustive list of available frameworks, and generation of a translation instruction set given the digital interconnectedness between the frameworks and the translation instruction sets. It is appreciated that the approaches discussed herein improve the technical field of computer performance by reducing bandwidth usage and increasing system responsiveness.

### Figure Description

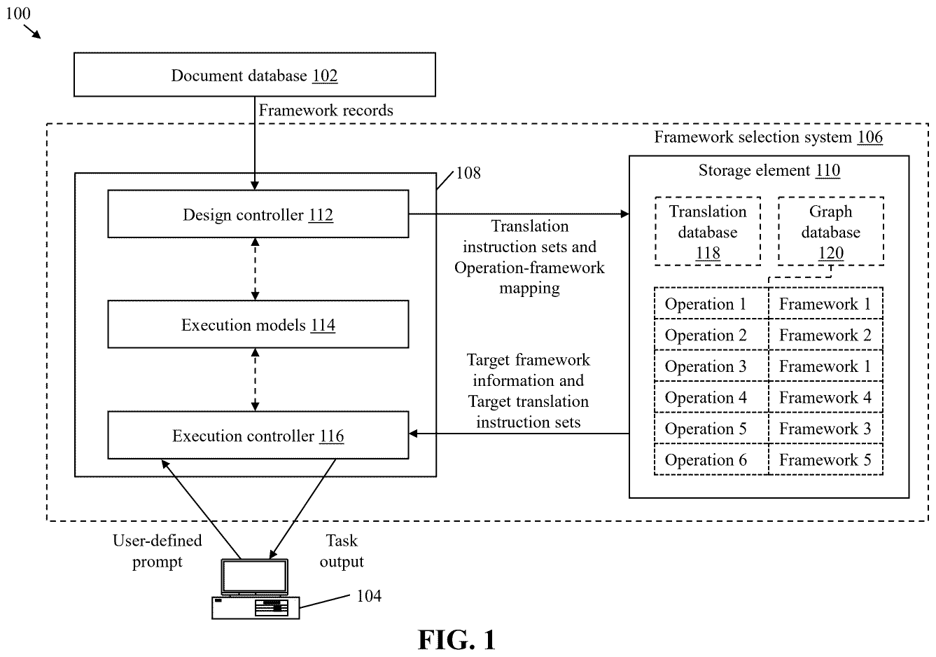

FIG. 1 illustrates an environment 100 of framework selection for task execution, consistent with disclosed embodiments of the present disclosure. Real-world problems in healthcare, finance, urban planning, or the like, may require real-time solutions. For example, a real-world problem such as traffic management may require a dynamic solution to handle traffic fluctuations caused by various conditions such as accidents, weather changes, or the like. The problem encompasses multiple nuances, such as the identification of pedestrians and vehicles, analysis required to predict the traffic pattern, as well as optimization of traffic light timings. Such problems are inherently associated with multiple Artificial Intelligence (AI) domains such as computer vision for detecting objects (e.g., pedestrians, vehicles, or the like), machine learning for predicting patterns, and reinforcement learning for optimizing traffic signal timings. For implementing such domains various frameworks (e.g., AI frameworks) may be used. For example, tasks like object detection and image processing in the field of computer vision can be implemented using frameworks such as PyTorch and OpenCV. Similarly, for pattern prediction, frameworks like TensorFlow and Scikit-learn may be employed. For optimization tasks, TensorFlow and PyTorch may be suitable options, along with specialized libraries like Rlib or Stable Baselines.

For the resolution of a single task, multiple frameworks may be available. For example, frameworks available for object detection may be PyTorch, OpenCV, Faster region-based convolutional neural network (Faster R-CNN), or the like. Each framework may have different functional characteristics for resolution of the same task. Each framework may execute the same task with a different approach and produce the same result (e.g., detection of a particular object). However, the frameworks may differ in their performance for executing the same task. Some frameworks may be more efficient than others, while some may be easier to implement. Further, each framework may be written in different programing languages, such as Python, C++, or the like. Therefore, each framework has a corresponding syntax associated therewith.

Conventionally, a technical expert may identify a framework for the resolution of a task. The framework may be identified based on the technical expert's knowledge. Thus, for an accurate and efficient task execution, the technical expert may be required to know all the available frameworks for the task execution, the structural aspects associated with each framework, or the like. Therefore, the selection of a suitable framework may be intensive and prone to human errors. The technical expert may not be aware of all the available frameworks or acquainted with the latest versions of each framework. This may result in the selection of unfit frameworks for task execution. Further, for the execution of a task, a translation between a format associated with the task to a format associated with a framework that is being utilized for execution of the task may be required. This translation, being a manual activity, is likely to be intensive and prone to human errors. These issues may result in failure to achieve real-time solutions for the tasks. This may prove to be fatal in situations where low latency is critical, such as fraud detection in finance.

To overcome the aforementioned issues, the present disclosure provides a different approach to framework selection for task execution. The environment 100 of the present disclosure may include a document database 102, a user device 104, and a framework selection system 106.

The document database 102 may be hosted on cloud storage (e.g., cloud services). Alternatively, the document database 102 may be stored in a storage element native to the framework selection system 106. The document database 102 may store information associated with various frameworks. The information associated with a framework may be stored as a plurality of framework records (hereinafter referred to as “framework records”). The framework records may contain a description of the framework, an architecture of the framework, a version of the framework, various libraries and extensions associated with the framework, various AI models that the framework may support, or the like. In an embodiment, the framework records may be retrieved from various public sources, for example, the GitHub repository associated with the framework. A server or computing device executing an Application Programming Interface (API) may send a request to the public sources to retrieve the framework records. The server or computing device executing the API may gather the data in a structured format. This data, associated with the framework, may be stored as the framework records in the document database 102.

The user device 104 may include suitable logic, circuitry, interfaces, and/or code, executable by the circuitry, that may be configured to perform one or more operations for interacting with the framework selection system 106 for execution of a task. The user device 104 may be associated with a user (not shown). The user device 104 may be used by the user to communicate a user-defined prompt to the framework selection system 106 and access a task output generated by the framework selection system 106 in response to the user-defined prompt. In an embodiment, the user-defined prompt may correspond to a natural-language task description. In another embodiment, the natural-language task description may be derived from the user-defined prompt. The natural-language task description may describe the real-world problem that requires resolution. The user device 104 may correspond to a cell-phone, a laptop, a tablet, a phablet, a desktop, a computer, or the like.

The framework selection system 106 may represent a platform that facilitates the efficient execution of tasks by selecting a suitable framework for each task. To implement efficient execution of a task, the framework selection system 106 may include processing circuitry 108 and a storage element 110. The storage element 110 may correspond to hardware storage (for example, hard drive, solid-state drive, or the like) or cloud storage (for example, cloud services).

The processing circuitry 108 may include suitable logic, circuitry, interfaces, and/or code, executable by the circuitry, that may be configured to select a suitable framework for task execution. The operations of the processing circuitry 108 can be divided into two parts: a design time implementation and a run time implementation. During design time, the processing circuitry 108 may be configured to generate translation instruction sets for various frameworks. Further, the processing circuitry 108 may be configured to generate a mapping between the tasks and the frameworks such that for each task, a target framework may be mapped. The processing circuitry 108 may be further configured to store the mapping between the tasks and the target frameworks in the storage element 110. During run time, for the execution of the task, the processing circuitry 108 may be configured to determine a target framework mapped to a task based on the mapping stored in the storage element 110. Further, the processing circuitry 108 may be configured to utilize a translation instruction set associated with the target framework for the execution of the task. The processing circuitry 108 may be further configured to generate a task output based on the task execution and present the task output on the user device 104. To execute the aforementioned operations, the processing circuitry 108 may include a design controller 112, a plurality of execution models 114 (hereinafter referred to as “execution models 114”), and an execution controller 116.

The execution models 114 may correspond to various AI models, for example, convolutional neural network (CNN), recurrent neural network (RNN), or the like. The AI models are computational algorithms that are designed to perform tasks efficiently sans human involvement. The tasks may include pattern recognition, decision-making, text interpretation, image interpretation, or the like. Each AI model may be associated with multiple frameworks. The association between a framework and the corresponding AI model may be based on the functionalities offered by the framework for the implementation, development, and execution of the AI model. A task may be executed by different AI frameworks associated with a corresponding AI model. For example, to execute a task of audio speech recognition associated with the RNN model, frameworks such as TensorFlow, PyTorch, Kaldi, or the like, may be utilized.

### Design Time Implementation

The design controller 112 may be communicatively coupled to the document database 102 and the storage element 110. The design controller 112 may include suitable logic, circuitry, interfaces, and/or code, executable by the circuitry, that may be configured to execute the design time implementation. The design controller 112 may be configured to retrieve, from the document database 102, the framework records of each available framework. Further, the design controller 112 may be configured to analyze the retrieved framework records and extract features associated with each framework based on the analysis. The extracted features may include a syntax and functional characteristics of the framework. The design controller 112 may be further configured to generate a translation instruction set for each framework based on the corresponding features. Each translation instruction set may translate an operation, matching at least one functional characteristic of the framework, from a predefined syntax to the syntax of the framework. Thus, a translation instruction set may be generated for each available framework. The design controller 112 may be further configured to store, in the storage element 110, the translation instruction sets generated for all available frameworks. The translation instruction sets may be stored in the storage element 110 as a translation database 118.

For any operation to be executed, multiple frameworks may be available. Thus, the design controller 112 may be configured to test all suitable frameworks for each operation to determine a target framework for each operation. For example, to determine the target framework for a reference operation, the design controller 112 may be configured to execute the reference operation based on all the frameworks that are associated with the reference operation. In an embodiment, one or more execution models, of the execution models 114, may be utilized for the execution. Further, the design controller 112 may be configured to obtain a set of performance metrics for each framework based on the corresponding execution. The target framework is determined based on the obtained set of performance metrics of all the frameworks associated with the reference operation. The design controller 112 may be further configured to store, in the storage element 110, a mapping between the operations and the target framework determined for each operation.

The operation-framework mapping may be stored in the storage element 110 as a graph database 120. As illustrated in FIG. 1, the operation-framework mapping may include two columns, one for operations and the other for the mapped target framework. One framework may be mapped to multiple operations. As illustrated in FIG. 1, ‘Framework 1’ is mapped to ‘Operation 1’ and ‘Operation 3’. This indicates that ‘Framework 1’ may comprise the capability of executing multiple operations. Further, ‘Framework 2’, ‘Framework 3’, ‘Framework 4’, and ‘Framework 5’, are mapped to ‘Operation 2’, ‘Operation 4’, ‘Operation 5’, and ‘Operation 6’, respectively.

### Run Time Implementation

The execution controller 116 may be communicatively coupled to the user device 104 and the storage element 110. The execution controller 116 may include suitable logic, circuitry, interfaces, and/or code, executable by the circuitry, that may be configured to execute the run time implementation. The execution controller 116 may be configured to convert the natural-language task description into various natural-language tasks. The execution controller 116 may be further configured to translate each natural-language task to an operation having the predefined syntax. In the present disclosure, a “task” has a natural-language format/syntax, whereas, an “operation” has the predefined syntax (e.g., a neo-syntax). The predefined syntax (e.g., the neo-syntax) is different from the syntax of the natural-language tasks.

The execution controller 116 may be further configured to select, based on the operation-framework mapping stored in the graph database 120, a target framework mapped to each operation. In an embodiment, the execution controller 116 may be configured to access the graph database 120 to retrieve target framework information for the execution of operations associated with the natural-language task description. The target framework information may include target frameworks mapped to the various operations.

The execution controller 116 may be further configured to translate each operation from the predefined syntax to a format associated with the corresponding target framework. In an embodiment, the execution controller 116 may be configured to access the translation database 118 to retrieve the translation instruction sets associated with the target frameworks identified for the various operations. The retrieved translation instruction sets of the target frameworks may be utilized for the translation of the operations from the predefined syntax to the formats associated with the target frameworks.

The execution controller 116 may be further configured to execute each translated operation based on the corresponding target framework. In an embodiment, an execution model, of the execution models 114, associated with the target framework may be utilized for the execution of the corresponding translated operation. The execution controller 116 may be further configured to generate the task output based on the execution of the translated operations and present the generated task output to the user on the user device 104.

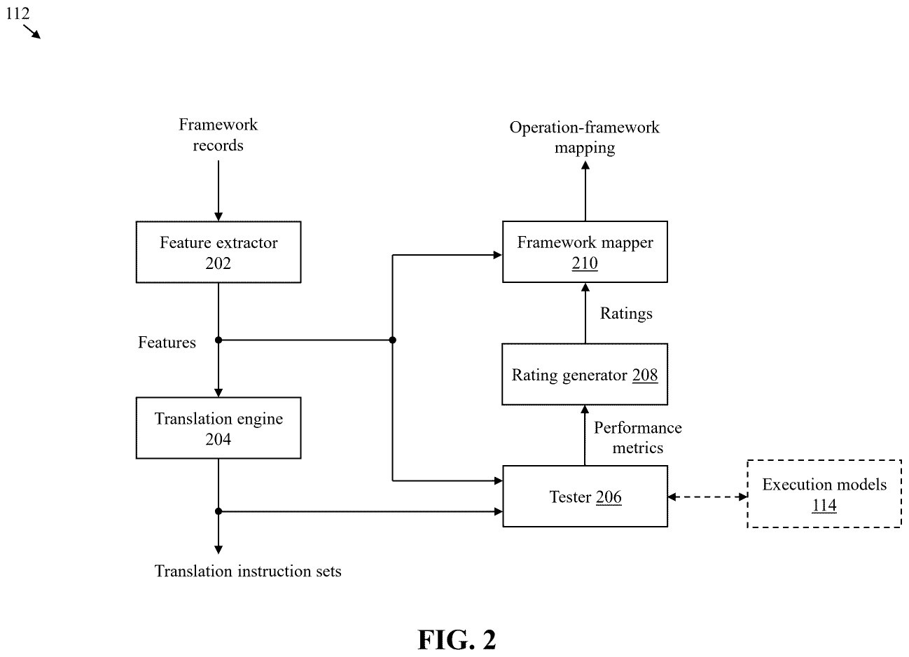

FIG. 2 is a block diagram of the design controller 112, consistent with disclosed embodiments of the present disclosure. The design controller 112 may be configured to execute the design time implementation. As illustrated in FIG. 2, the design controller 112 (e.g., the processing circuitry 108) may include a feature extractor 202, a translation engine 204, a tester 206, a rating generator 208, and a framework mapper 210.

The feature extractor 202 may be communicatively coupled to the document database 102. The feature extractor 202 may include suitable logic, circuitry, interfaces, and/or code, executable by the circuitry, that may be configured to extract features from the framework records. The feature extractor 202 may be configured to retrieve, from the document database 102, the framework records associated with each framework of a plurality of frameworks. The plurality of frameworks may correspond to a master list of available frameworks that can be utilized for task execution. The feature extractor 202 may be further configured to analyze the framework records associated with each framework. Based on the analysis of the framework records of each framework, the feature extractor 202 may be further configured to determine a plurality of features for the corresponding framework.

The plurality of features (hereinafter referred to as “features”) may include a syntax and a set of functional characteristics associated with the framework. The syntax may represent a specific format. That is to say, the syntax may correspond to specific rules that may define the structure of the underlying framework. In an embodiment, the syntax of each framework may depend on the underlying programming languages (e.g., Python, C++, or the like) that are utilized for building the corresponding framework. The set of functional characteristics associated with each framework may correspond to features and capabilities that may define how the corresponding framework may operate. In other words, the set of functional characteristics may correspond to a set of operations supported by a framework. For example, the OpenCV framework may be built for operations related to computer vision and image processing. Thus, the functional characteristics of the OpenCV framework may include object detection, image transformations, motion tracking, video processing, robotics, augmented reality, or the like. Similarly, Caffe is a deep learning framework often used in vision-related applications. Thus, the functional characteristics of the Caffe framework may include image recognition tasks, image classification tasks, or the like. In an embodiment, the feature extractor 202 may be configured to receive at least a first trigger. The first trigger may correspond to at least one of a group consisting of a user input or occurrence of a predetermined event. The predetermined event may include any system changes (e.g., changes in a framework record), lapse of a predefined time interval, or the like. The feature extractor 202 may analyze the framework records associated with each framework of the plurality of frameworks in response to the first trigger.

The translation engine 204 may be communicatively coupled to the feature extractor 202 and the storage element 110. The translation engine 204 may include suitable logic, circuitry, interfaces, and/or code, executable by the circuitry, that may be configured to enable framework syntax translation. The translation engine 204 may be configured to receive the features associated with each framework of the plurality of frameworks from the feature extractor 202. The translation engine 204 may be further configured to generate a translation instruction set for each framework of the plurality of frameworks based on the features of the corresponding framework. The translation instruction set may correspond to operational instructions that may comprise a logic for interacting with the framework. The translation instruction set of a framework may be configured to translate an associated operation from the predefined syntax to the syntax of the corresponding framework. The translation engine 204 may be further configured to store the translation instruction set generated for each framework in the storage element 110. Particularly, the translation engine 204 may store the translation database 118 in the storage element 110.

The tester 206 may be communicatively coupled to the feature extractor 202 and the translation engine 204. The tester 206 may include suitable logic, circuitry, interfaces, and/or code, executable by the circuitry, that may be configured to test the plurality of frameworks for various operations. The tester 206 may be configured to receive the features of each framework from the feature extractor 202. Further, the tester 206 may be configured to identify a first operation (also referred to as a “test operation”) to be utilized for framework testing. The tester 206 may be configured to identify, from the plurality of frameworks, one or more frameworks associated with the test operation. For example, at least one of the set of functional characteristics of each of the one or more frameworks matches the test operation. The tester 206 may be further configured to receive at least a second trigger. The second trigger may correspond to at least one of a group consisting of a user input, a lapse of a periodic time interval, an update to at least one of the plurality of frameworks, or detection of a new framework. The tester 206 may identify the one or more frameworks associated with the test operation in response to the second trigger.

The tester 206 may be further configured to execute the test operation based on each of the one or more frameworks. In an embodiment, the tester 206 may execute the test operation based on an execution model, of the execution models 114, associated with each of the one or more frameworks. In several embodiments, the test operation may have the predefined syntax. In such a scenario, the tester 206 may be configured to translate, prior to the execution, the test operation from the predefined syntax to the syntaxes of the one or more frameworks. In such a scenario, the tester 206 may be configured to utilize the translation instruction sets generated for each framework of the identified one or more frameworks. The tester 206 may be further configured to obtain a set of performance metrics for each framework of the one or more frameworks based on the execution of the test operation for the corresponding framework. In an embodiment, the set of performance metrics obtained for each framework may include the efficiency of the corresponding framework. However, in other embodiments, other performance metrics such as accuracy, ease of use, or the like, may be utilized.

The rating generator 208 may be communicatively coupled to the tester 206. The rating generator 208 may include suitable logic, circuitry, interfaces, and/or code, executable by the circuitry, that may be configured to rate the frameworks. The rating generator 208 may be configured to receive the set of performance metrics (hereinafter referred to as “performance metrics”) obtained for each framework of the identified one or more frameworks. The rating generator 208 may be further configured to generate one or more ratings for the one or more frameworks, respectively, based on the performance metrics obtained for each framework of the one or more frameworks. A rating is indicative of the suitability of the corresponding framework for executing the test operation. To generate a rating for each framework, the rating generator 208 may be further configured to execute a plurality of measurement models on the performance metrics obtained for the corresponding framework and generate a plurality of scores for the corresponding framework based on the execution of the plurality of measurement models on the performance metrics. In an embodiment, the plurality of measurement models may be executed in a parallel manner. The plurality of measurement models may include at least two of a group consisting of a representation learning model, a deep Q-network model, or a policy gradient model. Each rating is thus generated based on the plurality of scores generated for the corresponding framework. In an embodiment, the rating generated for each framework of the one or more frameworks corresponds to an aggregation of the plurality of scores associated with the corresponding framework.

Thus, if for the test operation, four frameworks are identified, the test operation is individually executed based on all four frameworks and associated execution models, and four sets of performance metrics are obtained. Three measurement models may then be executed on the performance metrics of one framework to obtain three scores which are aggregated to generate one rating for the framework. The process may be repeated for the remaining frameworks such that for the test operation, the four identified frameworks have four ratings.

The functions of the tester 206 and the rating generator 208 may be similarly repeated for all other available operations supported by the plurality of frameworks. For each operation, one or more frameworks are identified and each identified framework is assigned a rating.

The scope of the present disclosure is not limited to the execution of the plurality of measurement models on the performance metrics. In several embodiments, each rating may be a direct function of the obtained performance metrics (e.g., sans the measurement model execution).

The framework mapper 210 may be communicatively coupled to the feature extractor 202, the rating generator 208, and the storage element 110. The framework mapper 210 may include suitable logic, circuitry, interfaces, and/or code, executable by the circuitry, that may be configured to generate the operation-framework mapping. The framework mapper 210 may be configured to receive the one or more ratings associated with each of the plurality of frameworks (hereinafter referred to as the “ratings”). The framework mapper 210 may be further configured to select, for each operation, a target framework from the one or more frameworks associated with the corresponding operation. The target framework may be selected from the one or more frameworks based on the one or more ratings. In an embodiment, the target framework may have the highest rating among the one or more frameworks. Thus, for each operation, one target framework is selected.

The framework mapper 210 may be further configured to map the plurality of frameworks to a plurality of operations such that for each operation (e.g., the first operation), a corresponding target framework is mapped. In such a scenario, at least one of the set of functional characteristics of the target framework matches the first operation. Further, the translation instruction set of the target framework is configured to translate the first operation from the predefined syntax to the syntax of the target framework. The framework mapper 210 may be further configured to store the operation-framework mapping in the storage element 110. Particularly, the framework mapper 210 may store the graph database 120 in the storage element 110.

The scope of the present disclosure is not limited to the graph database 120 including exclusively the target framework identified for each operation. In numerous embodiments, the graph database 120 may include a mapping between the plurality of operations and the plurality of frameworks such that each operation has, mapped thereto, the related one or more frameworks and the one or more ratings assigned to the one or more frameworks, respectively. Each rating is indicative of a degree of suitability of the corresponding framework for executing the corresponding operation. In such an implementation, the framework most suited for the execution of any operation may be selected based on the ratings during the task execution.

The frameworks utilized in the design time implementation are not static and any changes in the frameworks result in re-assessment of the framework for task execution. For example, in an embodiment, the feature extractor 202 may be configured to determine whether at least one framework of the plurality of frameworks is updated. The update of the framework may correspond to changes in the framework records associated therewith. The determination may be executed in a periodic manner or based on the occurrence of a specified event. Based on the determination that the at least one framework is updated, the feature extractor 202 may be further configured to update the features associated with the updated framework. Further, the translation engine 204 may be configured to update the translation instruction set associated with the updated framework based on the updated features. Additionally, the rating generator 208 may be further configured to update, based on the updated features, a rating associated with the updated framework.

When the rating of the updated framework is updated, the framework mapper 210 may be further configured to determine whether the updated rating is higher than a rating associated with the target frameworks of all operations that match the set of functional characteristics of the updated framework (e.g., the target frameworks of all operations where the updated framework is one of the identified frameworks). For operations where the updated rating is lower than the ratings associated with the target frameworks, the operation-framework mapping remains the same. Conversely, for operations where the updated rating is higher than the ratings associated with the target frameworks, the framework mapper 210 may be configured to map the updated framework as the target framework for these operations. Thus, the present disclosure ensures that the framework selected for each operation of the plurality of operations has the latest framework version.

In an embodiment, a new framework may be added to the master list of available frameworks. The addition of the new framework may trigger the tester 206 to test the new framework. The tester 206 may be further configured to receive features of the newly added framework. Further, the tester 206 may be configured to identify operations that may be associated with the new framework. The tester 206 may be further configured to execute the identified operations based on the new framework. The rating generator 208 may be further configured to generate a rating for the new framework in a similar manner as described above. Further, the framework mapper 210 may be configured to determine whether the rating of the new framework for any of the operations is greater than the rating of the target frameworks mapped to these operations. For operations where the rating of the new framework is higher than the ratings associated with the target frameworks, the framework mapper 210 may be configured to map the new framework as the target framework for these operations. For example, for an object detection operation, the PyTorch framework may be mapped as the target framework. Further, a new framework (e.g., OpenCV) may be added, with at least one of the set of functional characteristics of the OpenCV framework matching the object detection operation. In such a scenario, the rating generated for the OpenCV framework may be compared with the rating of the PyTorch framework. If the rating of the OpenCV framework is higher than that of the PyTorch framework, the OpenCV framework may be mapped as the target framework for the object detection operation.

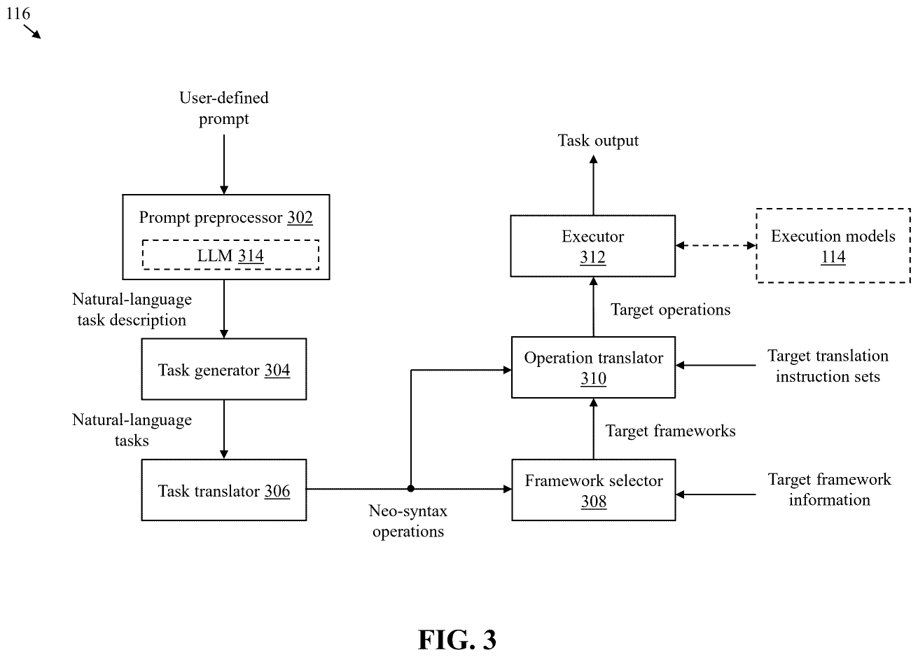

FIG. 3 is a block diagram of the execution controller 116, consistent with disclosed embodiments of the present disclosure. The execution controller 116 may be configured to execute the run time implementation. As illustrated in FIG. 3, the execution controller 116 may include a prompt preprocessor 302, a task generator 304, a task translator 306, a framework selector 308, an operation translator 310, and an executor 312.

The prompt preprocessor 302 may be communicatively coupled to the user device 104. The prompt preprocessor 302 may include suitable logic, circuitry, interfaces, and/or code, executable by the circuitry, that may be configured to generate the natural-language task description. The user of the user device 104 may want to execute a task by utilizing the framework selection system 106. The user may thus communicate with the framework selection system 106 by way of the user device 104. The user may provide the user-defined prompt defining the task to the framework selection system 106. The prompt preprocessor 302 may be configured to receive the user-defined prompt from the user device 104. In one embodiment, the user-defined prompt may not be detailed. That is to say, the user-defined prompt may not comprise all the required details for the execution of the task. For example, the user-defined prompt may be ambiguous and thereby may lack clarity about the task. In such a scenario, the prompt preprocessor 302 may be configured to tune the user-defined prompt. In an embodiment, the prompt preprocessor 302 may include a large language model (LLM) 314 that may be utilized for tuning the user-defined prompt. Thus, the prompt preprocessor 302 may be configured to generate, using the LLM 314, the natural-language task description based on the user-defined prompt. Examples of the LLM 314 may include Generative Pre-trained Transformer (GPT)-3, GPT-4, Bidirectional Encoder Representations from Transformers (BERT), or the like.

The scope of the present disclosure is not limited to the utilization of the LLM 314. In several embodiments, the user-defined prompt may include detailed information that clearly outlines the objective of the user for the task execution. In other words, the user-defined prompt may correspond to the natural-language task description. In such an embodiment, the prompt tuning by the LLM 314 may not be required.

The task generator 304 may be communicatively coupled to the prompt preprocessor 302. The task generator 304 may include suitable logic, circuitry, interfaces, and/or code, executable by the circuitry, that may be configured to process the natural-language task description. The task generator 304 may be configured to receive the natural-language task description from the prompt preprocessor 302. Further, the task generator 304 may be configured to derive a plurality of natural-language tasks (hereinafter referred to as “natural-language tasks”) from the natural-language task description. The task generator 304 may be further configured to determine a sequence of execution for the plurality of natural-language tasks.

The task translator 306 may be communicatively coupled to the task generator 304. The task translator 306 may include suitable logic, circuitry, interfaces, and/or code, executable by the circuitry, that may be configured to process the natural-language tasks. The task translator 306 may be configured to receive the natural-language tasks from the task generator 304 and translate each natural-language task to an operation having the predefined syntax. The predefined syntax may define an identifier, an input, and an output. The input may represent an exact operation to be performed for a corresponding natural-language task. The input may include one or more keywords associated with a brief description of the corresponding natural-language task. The output may correspond to a desired outcome for the corresponding input.

Thus, the task generator 304 and the task translator 306, collectively, may be configured to convert the natural-language task description into a plurality of operations having the predefined syntax. In an embodiment, the natural-language task description is converted into the plurality of operations using natural language processing.

The framework selector 308 may be communicatively coupled to the task translator 306 and the storage element 110. The framework selector 308 may include suitable logic, circuitry, interfaces, and/or code, executable by the circuitry, that may be configured to select frameworks suitable for execution of the plurality of operations. The framework selector 308 may be configured to receive the plurality of operations having the predefined syntax (hereinafter referred to as “neo-syntax operations”) from the task translator 306. Further, the framework selector 308 may be configured to select, for each neo-syntax operation, a framework associated with an execution of the corresponding operation. In an embodiment, the framework selector 308 may be configured to access the graph database 120 stored in the storage element 110 and retrieve the target framework information. The target framework information may include the mapping between the plurality of operations and a target framework mapped to each operation. Thus, based on the target framework information, the framework selected for executing each neo-syntax operation corresponds to the target framework mapped to the corresponding operation.

The operation translator 310 may be communicatively coupled to the task translator 306, the framework selector 308, and the storage element 110. The framework selector 308 may include suitable logic, circuitry, interfaces, and/or code, executable by the circuitry, that may be configured to enable translation of the neo-syntax operations. The operation translator 310 may be configured to receive the neo-syntax operations and the selected target frameworks for the neo-syntax operations from the task translator 306 and the framework selector 308, respectively. The operation translator 310 may be configured to translate the neo-syntax operations, with each neo-syntax operation being translated from the predefined syntax to a syntax of the associated target framework. In an embodiment, the operation translator 310 may be configured to receive at least a third trigger. The third trigger may correspond to at least one of a group consisting of a user input, lapse of a periodic time interval, or occurrence of a predetermined event. The operation translator 310 may translate the neo-syntax operations in response to the third trigger. In an embodiment, the operation translator 310 may be configured to access the translation database 118 stored in the storage element 110 and retrieve the translation instruction sets associated with the identified target frameworks. The retrieved translation instruction sets are hereinafter referred to as “target translation instruction sets”. The operation translator 310 may translate each neo-syntax operation from the predefined syntax to the syntax associated with the corresponding target framework using a translation instruction set generated for the corresponding target framework.

The executor 312 may be communicatively coupled to the operation translator 310 and the user device 104. The executor 312 may include suitable logic, circuitry, interfaces, and/or code, executable by the circuitry, that may be configured to execute the translated operations. The executor 312 may be configured to receive the translated neo-syntax operations (hereinafter referred to as “target operations”) from the operation translator 310. The executor 312 may be configured to identify, from the execution models 114, an execution model for each target operation. The execution model, for each target operation, may be identified based on the target framework associated therewith. The executor 312 may be further configured to execute the target operations. Each target operation may be executed based on the corresponding framework and using the determined execution model associated with the corresponding framework. For example, an operation of image classification may be executed based on TensorFlow as the framework and by using CNN as the execution model. In an embodiment, the target operations may be executed concurrently. In another embodiment, the target operations may be executed sequentially. In yet another embodiment, some of the target operations may be executed concurrently, and the remaining may be executed sequentially.

The executor 312 may be configured to generate a task output based on the execution of the target operations. In an example, the natural-language task description may correspond to: “In the image file, identify a room and determine the total number of persons present in the room”. For this natural-language task description, the task output may correspond to the image file with the room and persons identified and the total number indicated. In another example, the natural-language task description may correspond to: “Process a video file and identify a floor in the video file”. For this natural-language task description, the task output may correspond to the floor being identified in the video file. Further, the executor 312 may be configured to present the task output to the user on the user device 104.

The scope of the present disclosure is not limited to the target framework being retrieved from the storage element 110 (e.g., the graph database 120). In several embodiments, the graph database 120 may include a mapping between the plurality of operations (e.g., the neo-syntax operations) and the plurality of frameworks such that each operation has, mapped thereto, one or more frameworks, of the plurality of frameworks, and one or more ratings assigned to the one or more frameworks, respectively. Each rating may be indicative of a degree of suitability of the corresponding framework for executing the corresponding operation. In such cases, the framework selected for executing each neo-syntax operation has the highest rating among the one or more frameworks mapped to the corresponding operation.

The disclosed embodiments encompass numerous advantages including efficient task execution by automated performance-based framework selection. The systems and methods disclosed herein allow for a real-time and effective suitable framework selection based on the operational efficiency of the framework for the corresponding task. The framework selection process may be sans (devoid of) human involvement. Therefore, the human errors introduced while determination of a suitable framework may be avoided, leading to a further increase in the performance. Notably, the time introduced due to manual translation may be significantly reduced due to real-time translation by utilization of translation instruction sets, thereby further increasing the efficiency of the task execution. Additionally, the user-defined prompt may be leveraged by utilizing the LLMs, therefore, technical skills may not be required for task execution. Thus, the solution provided by the present disclosure may be leveraged by all groups of people. The application area of the present disclosure may include any domain that utilizes various frameworks for its execution such as healthcare, traffic management, urban planning, or the like.

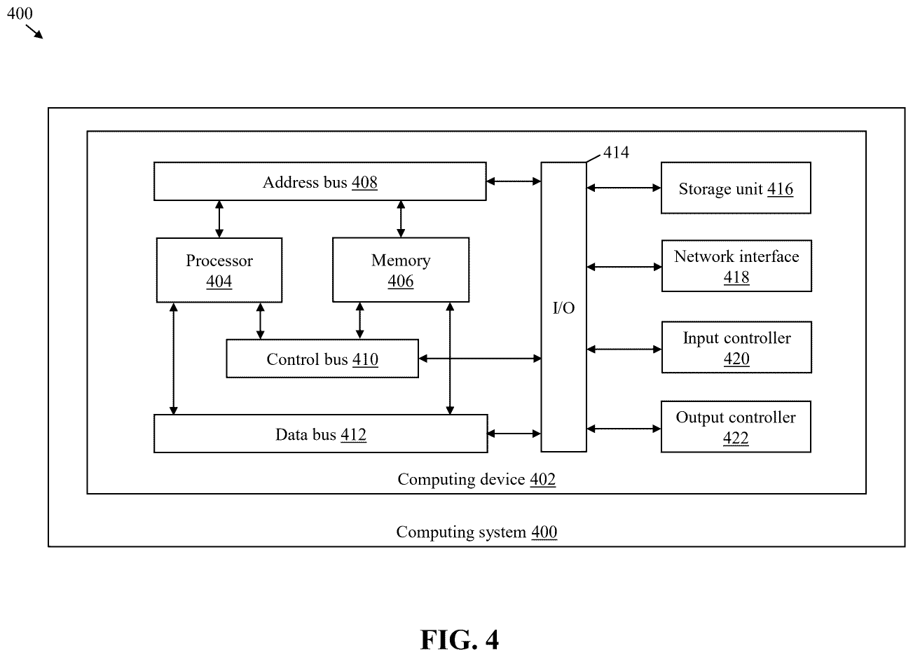

FIG. 4 shows an example computing system 400 for carrying out the methods of the present disclosure, consistent with disclosed embodiments of the present disclosure. Specifically, FIG. 4 shows a block diagram of an embodiment of the computing system 400 according to example embodiments of the present disclosure.

The computing system 400 may be configured to perform any of the operations disclosed herein. The computing system 400 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 400 is a distributed system configured to function using multiple computing machines interconnected via a data network or bus system.

The computing system 400 includes computing devices (such as a computing device 402). The computing device 402 includes one or more processors (such as a processor 404) and a memory 406. The processor 404 may be any general-purpose processor(s) configured to execute a set of instructions. For example, the processor 404 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 404 may be multiple processing units, a single processing core, multiple processing cores, special purpose processing cores, co-processors, or any combination thereof. The processor 404 may be communicatively coupled to the memory 406 via an address bus 408, a control bus 410, and a data bus 412.

The memory 406 may include non-volatile memories such as a read-only memory (ROM), a programable read-only memory (PROM), an erasable programmable read-only memory (EPROM), a flash memory, or any other device capable of storing program instructions or data with or without applied power. The memory 406 may also include volatile memories, such as a random-access-memory (RAM), a static random-access-memory (SRAM), a dynamic random-access-memory (DRAM), and a synchronous dynamic random-access-memory (SDRAM). The memory 406 may include single or multiple memory modules. While the memory 406 is depicted as part of the computing device 402, a person skilled in the art will recognize that the memory 406 can be separate from the computing device 402.

The memory 406 may store information that can be accessed by the processor 404. For instance, the memory 406 (e.g., one or more non-transitory computer-readable storage mediums, memory devices) may include computer-readable instructions (not shown) that can be executed by the processor 404. The computer-readable instructions may be software written in any suitable programming language or may be implemented in hardware. Additionally, or alternatively, the computer-readable instructions may be executed in logically and/or virtually separate threads on the processor 404. For example, the memory 406 may store instructions (not shown) that when executed by the processor 404 cause the processor 404 to perform operations such as any of the operations and functions for which the computing system 400 is configured, as described herein. Additionally, or alternatively, the memory 406 may store data (not shown) that can be obtained, received, accessed, written, manipulated, created, and/or stored. The data can include, for instance, the data and/or information described herein in relation to FIGS. 1-3. In some implementations, the computing device 402 may obtain from and/or store data in one or more memory device(s) that are remote from the computing system 400.

The computing device 402 may further include an input/output (I/O) interface 414 communicatively coupled to the address bus 408, the control bus 410, and the data bus 412. The data bus 412 may include a plurality of tunnels that may support communication in the framework selection system 106. The I/O interface 414 is configured to couple to one or more external devices (e.g., to receive and send data from/to one or more external devices). Such external devices, along with the various internal devices, may also be known as peripheral devices. The I/O interface 414 may include both electrical and physical connections for operably coupling the various peripheral devices to the computing device 402. The I/O interface 414 may be configured to communicate data, addresses, and control signals between the peripheral devices and the computing device 402. The I/O interface 414 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 414 is configured to implement only one interface or bus technology. Alternatively, the I/O interface 414 is configured to implement multiple interfaces or bus technologies. The I/O interface 414 may include one or more buffers for buffering transmissions between one or more external devices, internal devices, the computing device 402, or the processor 404. The I/O interface 414 may couple the computing device 402 to various input devices, including mice, touch screens, scanners, biometric readers, electronic digitizers, sensors, receivers, touchpads, trackballs, cameras, microphones, keyboards, any other pointing devices, or any combinations thereof. The I/O interface 414 may couple the computing device 402 to various output devices, including video displays, speakers, printers, projectors, tactile feedback devices, automation control, robotic components, actuators, motors, fans, solenoids, valves, pumps, transmitters, signal emitters, lights, and so forth.

The computing system 400 may further include a storage unit 416, a network interface 418, an input controller 420, and an output controller 422. The storage unit 416, the network interface 418, the input controller 420, and the output controller 422 are communicatively coupled to the central control unit (e.g., the memory 406, the address bus 408, the control bus 410, and the data bus 412) via the I/O interface 414. The network interface 418 communicatively couples the computing system 400 to one or more networks such as wide area networks (WAN), local area networks (LAN), intranets, the Internet, wireless access networks, wired networks, mobile networks, telephone networks, optical networks, or combinations thereof. The network interface 418 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 416 is a computer-readable medium, preferably a non-transitory computer-readable medium, comprising one or more programs, the one or more programs comprising instructions which when executed by the processor 404 cause the computing system 400 to perform the method steps of the present disclosure. Alternatively, the storage unit 416 is a transitory computer-readable medium. The storage unit 416 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 416 stores one or more operating systems, application programs, program modules, data, or any other information. The storage unit 416 is part of the computing device 402. Alternatively, the storage unit 416 is part of one or more other computing machines that are in communication with the computing device 402, such as servers, database servers, cloud storage, network attached storage, and so forth.

The input controller 420 may include suitable logic, circuitry, interfaces, and/or code, executable by the circuitry, that may be configured to control one or more input devices that may be configured to receive an input for the framework selection system 106. The output controller 422 may include suitable logic, circuitry, interfaces, and/or code, executable by the circuitry, that may be configured to control one or more output devices that may be configured to render/output the outcome of the operation executed to process the received input.

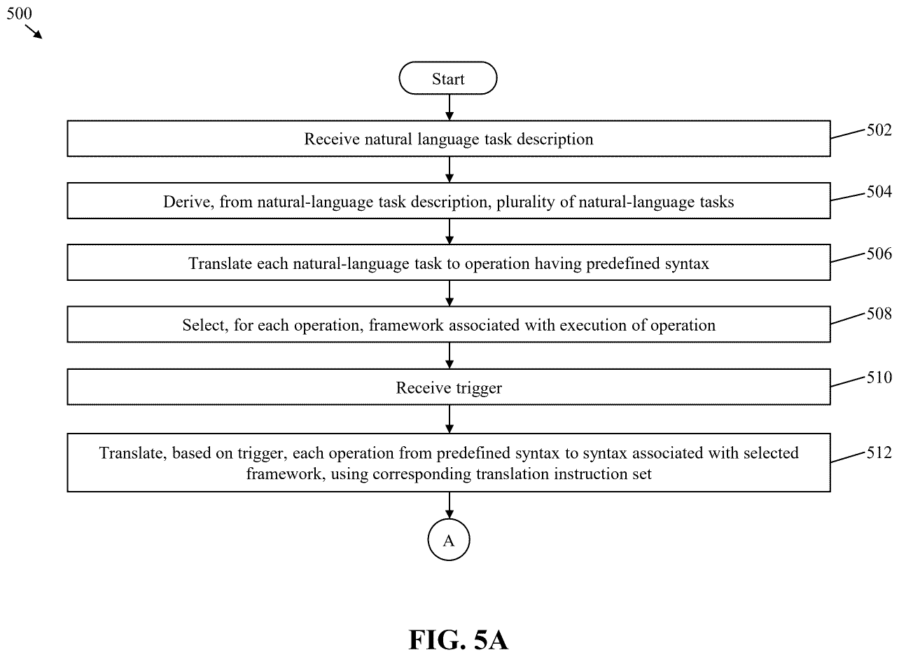

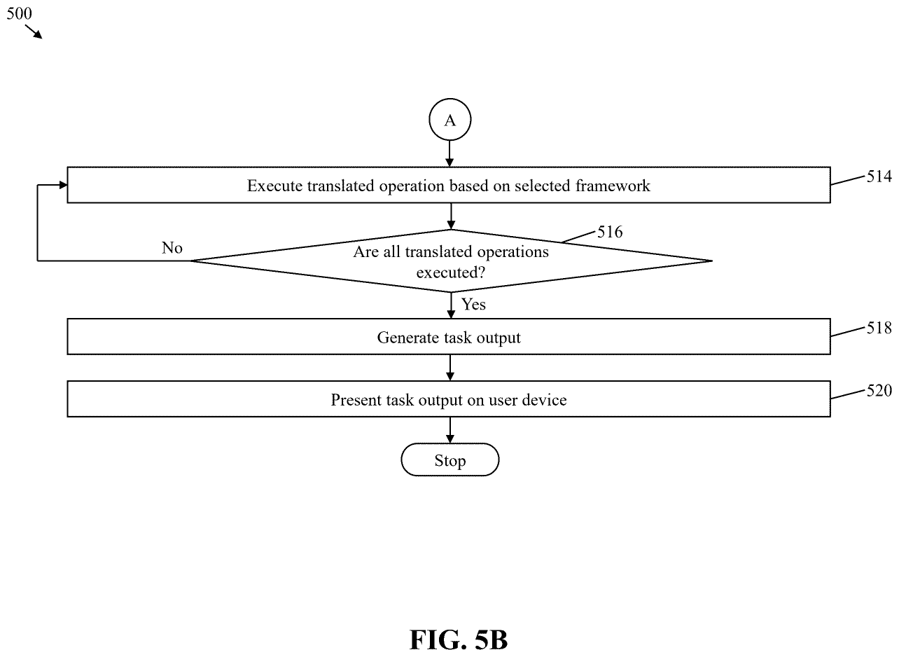

FIGS. 5A and 5B collectively, represents a flowchart 500 that illustrates a method for framework selection for task execution at run time implementation, consistent with disclosed embodiments of the present disclosure.

Referring to FIG. 5A, at 502, the processing circuitry 108 (e.g., the task generator 304) may receive a natural-language task description. At 504, the processing circuitry 108 (e.g., the task generator 304) may derive, from the natural-language task description, the plurality of natural-language tasks. At 506, the processing circuitry 108 (e.g., the task translator 306) may translate each natural-language task to an operation having the predefined syntax. At 508, the processing circuitry 108 (e.g., the framework selector 308) may select, for each operation (e.g., for each neo-syntax operation), a framework associated with the execution of the operation. At 510, the processing circuitry 108 (e.g., the operation translator 310) may receive a trigger (e.g., the third trigger). At 512, the processing circuitry 108 (e.g., the operation translator 310) may translate, based on the trigger, each operation from the predefined syntax to a syntax associated with the selected framework, using a corresponding translation instruction set.

Referring to FIG. 5B, at 514, the processing circuitry 108 (e.g., the executor 312) may execute a translated operation based on the selected framework. At 516, the processing circuitry 108 (e.g., the executor 312) may determine whether all the translated operations are executed. If at 516, it is determined that all translated operations are not executed, 514 is executed again until all the translated operations are executed. Conversely, if at 516, it is determined that all translated operations are executed, 518 is executed. At 518, the processing circuitry 108 (e.g., the executor 312) may generate the task output. At 520, the processing circuitry 108 (e.g., the executor 312) may present the task output on the user device 104.

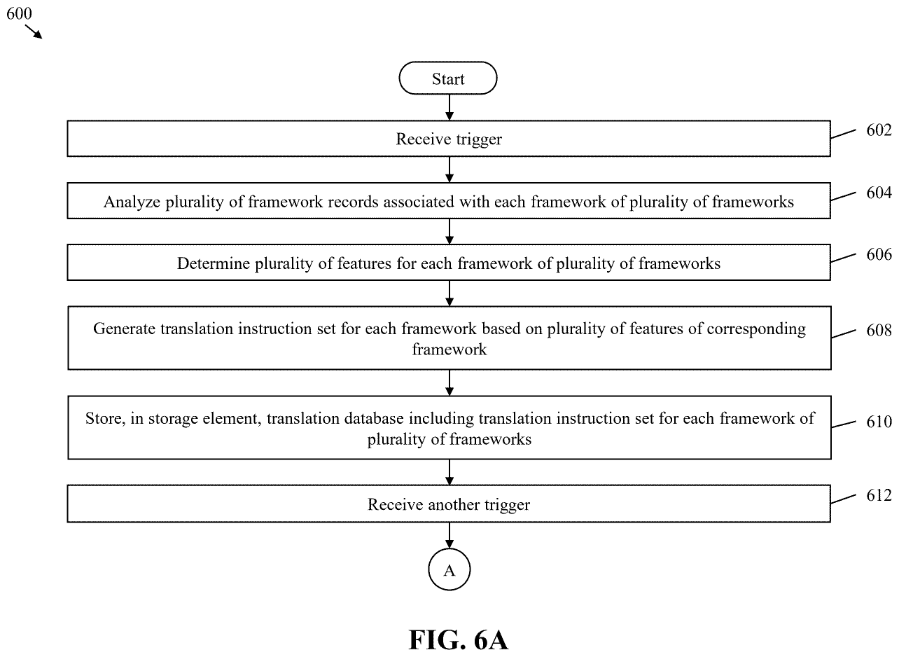

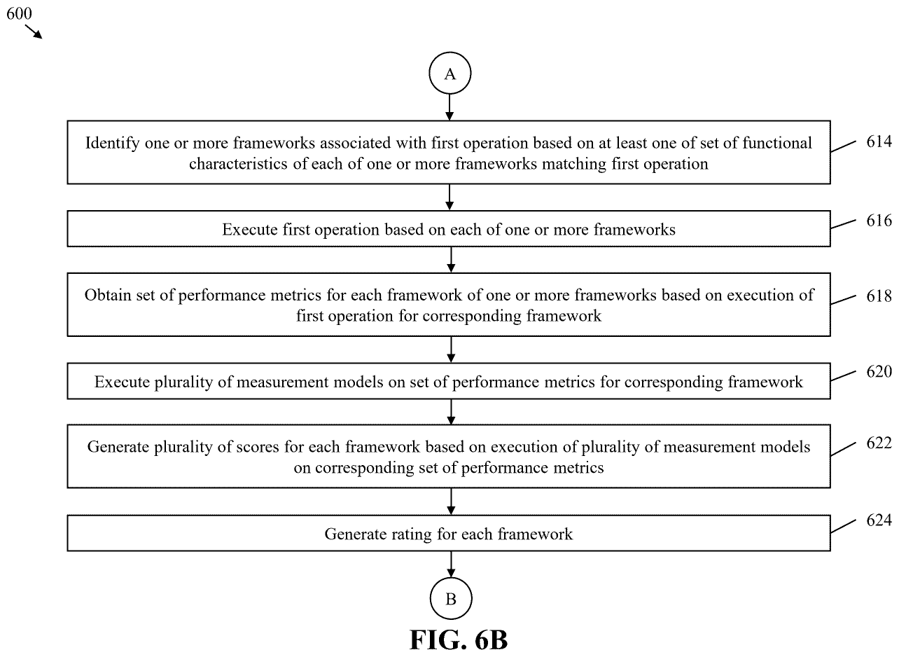

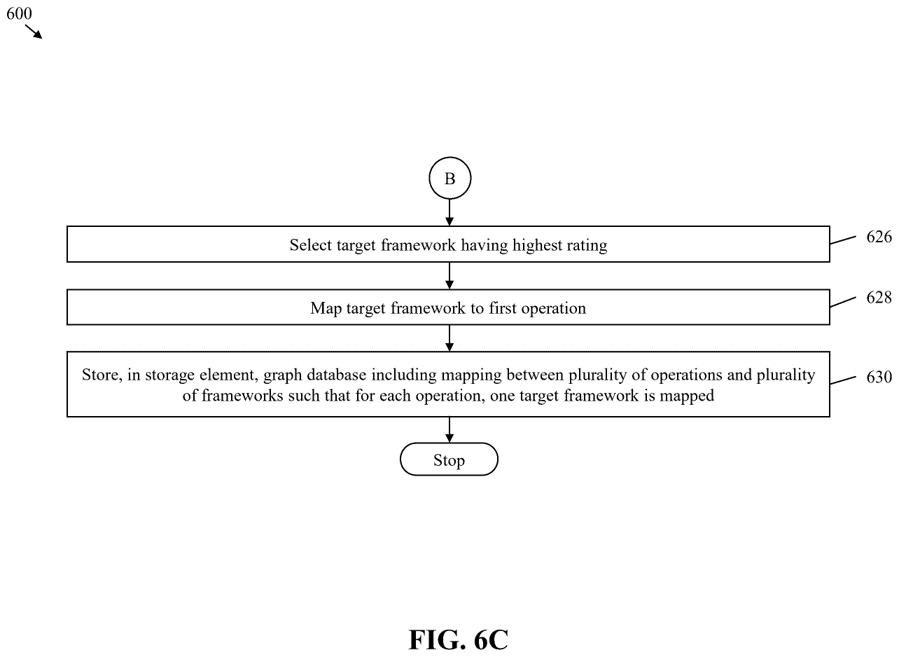

FIGS. 6A-6C collectively, represents a flowchart 600 that illustrates a method for framework selection for task execution at design time implementation, consistent with disclosed embodiments of the present disclosure.

Referring to FIG. 6A, at 602, the processing circuitry 108 (e.g., the feature extractor 202) may receive a trigger (e.g., the first trigger). At 604, the processing circuitry 108 (e.g., the feature extractor 202) may analyze, based on the trigger, a plurality of framework records associated with each framework of a plurality of frameworks. At 606, the processing circuitry 108 (e.g., the feature extractor 202) may determine, based on the analysis, a plurality of features for each framework of the plurality of frameworks. At 608, the processing circuitry 108 (e.g., the translation engine 204) may generate a translation instruction set for each framework based on the plurality of features of the corresponding framework. At 610, the processing circuitry 108 (e.g., the translation engine 204) may store, in the storage element 110, the translation database 118 including the translation instruction set for each framework of the plurality of frameworks.

At 612, the processing circuitry 108 (e.g., the tester 206) may receive another trigger (e.g., the second trigger). Referring to FIG. 6B, at 614, the processing circuitry 108 (e.g., the tester 206) may identify one or more frameworks associated with a first operation based on at least one of a set of functional characteristics of each of the one or more frameworks matching the first operation. At 616, the processing circuitry 108 (e.g., the tester 206) may execute the first operation based on each of the one or more frameworks.

At 618, the processing circuitry 108 (e.g., the tester 206) may obtain a set of performance metrics for each framework of the one or more frameworks based on the execution of the first operation for the corresponding framework. At 620, the processing circuitry 108 (e.g., the rating generator 208) may execute a plurality of measurement models on the set of performance metrics for the corresponding framework. At 622, the processing circuitry 108 (e.g., the rating generator 208) may generate a plurality of scores for each framework based on the execution of the plurality of measurement models on the corresponding set of performance metrics. At 624, the processing circuitry 108 (e.g., the rating generator 208) may generate a rating for each framework.

Referring to FIG. 6C, at 626, the processing circuitry 108 (e.g., the framework mapper 210) may select a target framework having the highest rating. At 628, the processing circuitry 108 (e.g., the framework mapper 210) may map the target framework to the first operation. At 630, the processing circuitry 108 (e.g., the framework mapper 210) may store, in the storage element 110, the graph database 120 including the mapping between a plurality of operations and the plurality of frameworks such that for each operation, one target framework is mapped.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for framework selection for task execution. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. A system, comprising:
   processing circuitry configured to:
      convert a natural-language task description into a plurality of operations having a predefined syntax;
      select, for each operation of the plurality of operations, a framework associated with an execution of the corresponding operation;
      translate the plurality of operations, with each operation being translated from the predefined syntax to a syntax of the associated framework; and
      execute the translated plurality of operations, wherein each translated operation, of the translated plurality of operations, is executed based on the associated framework.
2. The system of 1, wherein the processing circuitry converts the natural-language task description into the plurality of operations using natural language processing.
3. The system of 1, wherein to convert the natural-language task description into the plurality of operations having the predefined syntax, the processing circuitry is further configured to:
   derive a plurality of natural-language tasks from the natural-language task description; and
   translate each natural-language task, of the plurality of natural-language tasks, to an operation, of the plurality of operations, having the predefined syntax.
4. The system of 1, wherein the natural-language task description corresponds to a user-defined prompt.
5. The system of 1, wherein the processing circuitry is further configured to:
   receive a user-defined prompt; and
   generate, using a large language model, the natural-language task description based on the user-defined prompt.
6. The system of 1, further comprising a storage element configured to store a database including a mapping between the plurality of operations and a plurality of frameworks such that a target framework, of the plurality of frameworks, is mapped to each operation of the plurality of operations.
7. The system of 6, wherein the framework selected for executing each operation of the plurality of operations corresponds to the target framework mapped to the corresponding operation.
8. The system of 1, further comprising a storage element configured to store a database including a mapping between the plurality of operations and a plurality of frameworks such that each operation has, mapped thereto, one or more frameworks, of the plurality of frameworks, and one or more ratings assigned to the one or more frameworks, respectively, wherein each of the one or more ratings is indicative of a degree of suitability of the corresponding framework for executing the corresponding operation.
9. The system of 8, wherein the framework selected for executing each operation of the plurality of operations has the highest rating among the one or more frameworks mapped to the corresponding operation.
10. The system of 1, wherein the translated plurality of operations are executed concurrently or sequentially.
11. The system of 1, wherein the processing circuitry is further configured to generate a task output based on the execution of the translated plurality of operations.
12. The system of 11, wherein the processing circuitry is further configured to present the task output on a user device associated with the system.
13. The system of 1, wherein the processing circuitry is further configured to receive one or more triggers, and wherein the processing circuitry translates the plurality of operations in response to the one or more triggers.
14. The system of 13, wherein the one or more triggers correspond to at least one of a group consisting of a user input, lapse of a periodic time interval, or occurrence of a predetermined event.
15. The system of 1, wherein the processing circuitry translates each operation of the plurality of operations from the predefined syntax to the syntax associated with the corresponding framework using a translation instruction set generated for the corresponding framework.
16. The system of 1, wherein the processing circuitry executes each translated operation of the translated plurality of operations using an execution model associated with the corresponding framework.
17. A method, comprising:
converting, by processing circuitry, a natural-language task description into a plurality of operations having a predefined syntax;
selecting, by the processing circuitry, for each operation of the plurality of operations, a framework associated with an execution of the corresponding operation;
translating, by the processing circuitry, the plurality of operations, with each operation being translated from the predefined syntax to a syntax of the associated framework; and
executing, by the processing circuitry, the translated plurality of operations, wherein each translated operation, of the translated plurality of operations, is executed based on the associated framework.
18. A system, comprising:
   processing circuitry configured to:
      determine, for each framework of a plurality of frameworks, a plurality of features comprising a syntax and a set of functional characteristics of the corresponding framework;
      generate a translation instruction set for each framework of the plurality of frameworks based on the plurality of features of the corresponding framework; and
      map the plurality of frameworks to a plurality of operations such that for a first operation, a target framework is mapped, wherein at least one of the set of functional characteristics of the target framework matches the first operation, and wherein the translation instruction set of the target framework is configured to translate the first operation from a predefined syntax to the syntax of the target framework.
19. The system of 20,
   wherein the processing circuitry is further configured to analyze a plurality of framework records associated with each framework of the plurality of frameworks, and
   wherein the plurality of features for each framework of the plurality of frameworks are determined based on the analysis of the plurality of framework records associated with the corresponding framework.
20. The system of 19, wherein the processing circuitry is further configured to receive one or more triggers, and wherein the processing circuitry analyzes the plurality of framework records associated with each framework of the plurality of frameworks in response to the one or more triggers.
21. The system of 20, wherein the one or more triggers correspond to at least one of a group consisting of a user input or occurrence of a predetermined event.
22. The system of 18, wherein the processing circuitry is further configured to:
   identify, from the plurality of frameworks, one or more frameworks associated with the first operation, wherein at least one of the set of functional characteristics of each of the one or more frameworks matches the first operation;
   execute the first operation based on each of the one or more frameworks;
   obtain a set of performance metrics for each framework of the one or more frameworks based on the execution of the first operation for the corresponding framework; and
   generate one or more ratings for the one or more frameworks, respectively, based on the set of performance metrics obtained for each framework of the one or more frameworks, wherein the target framework for the first operation is selected from the one or more frameworks based on the one or more ratings.
23. The system of 22, wherein the processing circuitry is further configured to receive one or more triggers, and wherein the processing circuitry identifies the one or more frameworks associated with the first operation in response to the one or more triggers.
24. The system of 23, wherein the one or more triggers correspond to at least one of a group consisting of a user input, a lapse of a periodic time interval, an update to at least one of the plurality of frameworks, or detection of a new framework.
25. The system of 22, wherein the target framework has the highest rating among the one or more frameworks.
26. The system of 22, wherein to generate a rating, of the one or more ratings, for each framework of the one or more frameworks, the processing circuitry is further configured to:
   execute a plurality of measurement models on the set of performance metrics for the corresponding framework; and
   generate a plurality of scores for the corresponding framework based on the execution of the plurality of measurement models on the set of performance metrics, wherein the rating is generated based on the plurality of scores.
27. The system of 26, wherein the rating generated for each framework of the one or more frameworks corresponds to an aggregation of the plurality of scores associated with the corresponding framework.
28. The system of 26, wherein the plurality of measurement models comprise at least two of a group consisting of a representation learning model, a deep Q-network model, or a policy gradient model.
29. The system of 18, wherein the set of functional characteristics of each framework of the plurality of frameworks corresponds to a set of operations supported by the corresponding framework.
30. The system of 18, further comprising a storage element, wherein the processing circuitry is coupled to the storage element, and configured to store a database including a mapping between the plurality of operations and the plurality of frameworks in the storage element.
31. The system of 18, further comprising a storage element, wherein the processing circuitry is coupled to the storage element, and configured to store a database including the translation instruction set for each framework of the plurality of frameworks.
32. The system of 18, wherein the processing circuitry is further configured to:
   determine whether at least one framework of the plurality of frameworks is updated;
   update, based on the determination that the at least one framework is updated, the plurality of features of the at least one framework; and
   update the translation instruction set associated with the at least one framework based on the updated plurality of features.
33. The system of 32, wherein the update of the at least one framework corresponds to changes in a plurality of framework records associated with the at least one framework.
34. The system of 32, wherein the processing circuitry is further configured to update, based on the updated plurality of features, a rating associated with the at least one framework.
35. The system of 18, wherein the processing circuitry is further configured to:
   identify, from the plurality of frameworks, one or more frameworks associated with the first operation, wherein at least one of the set of functional characteristics of each of the one or more frameworks matches the first operation;
   generate one or more ratings for the one or more frameworks, respectively, wherein the target framework for the first operation is selected from the one or more frameworks based on the one or more ratings;
   determine whether at least one framework of the one or more frameworks is updated;
   update, based on the determination that the at least one framework is updated, a rating, of the one or more ratings, associated with the at least one framework;
   determine whether the updated rating is higher than a rating associated with the target framework; and
   map, based on the determination that the updated rating is higher than the rating associated with the target framework, the updated framework as the target framework for the first operation.

### 36. A method comprising:

determining, by processing circuitry, for each framework of a plurality of frameworks, a plurality of features comprising a syntax and a set of functional characteristics of the corresponding framework;
generating, by the processing circuitry, a translation instruction set for each framework of the plurality of frameworks based on the plurality of features of the corresponding framework; and
mapping, by the processing circuitry, the plurality of frameworks to a plurality of operations such that for a first operation, a target framework is mapped, wherein at least one of the set of functional characteristics of the target framework matches the first operation, and wherein based on the translation instruction set of the target framework, the first operation is translated from a predefined syntax to the syntax of the target framework.

What is claimed is:

1. A system, comprising:
processing circuitry configured to:
determine, for each framework of a plurality of frameworks, a plurality of features comprising a syntax and a set of functional characteristics of the corresponding framework;
generate a translation instruction set for each framework of the plurality of frameworks based on the plurality of features of the corresponding framework; and
map the plurality of frameworks to a plurality of operations such that for a first operation, a target framework is mapped, wherein at least one of the set of functional characteristics of the target framework matches the first operation, and wherein the translation instruction set of the target framework is configured to translate the first operation from a predefined syntax to the syntax of the target framework.

2. The system of claim 1,
wherein the processing circuitry is further configured to analyze a plurality of framework records associated with each framework of the plurality of frameworks, and
wherein the plurality of features for each framework of the plurality of frameworks are determined based on the analysis of the plurality of framework records associated with the corresponding framework.

3. The system of claim 2, wherein the processing circuitry is further configured to receive one or more triggers, and wherein the processing circuitry analyzes the plurality of framework records associated with each framework of the plurality of frameworks in response to the one or more triggers.

4. The system of claim 3, wherein the one or more triggers correspond to at least one of a group consisting of a user input or occurrence of a predetermined event.

5. The system of claim 1, wherein the processing circuitry is further configured to:
identify, from the plurality of frameworks, one or more frameworks associated with the first operation, wherein at least one of the set of functional characteristics of each of the one or more frameworks matches the first operation;
execute the first operation based on each of the one or more frameworks;
obtain a set of performance metrics for each framework of the one or more frameworks based on the execution of the first operation for the corresponding framework; and
generate one or more ratings for the one or more frameworks, respectively, based on the set of performance metrics obtained for each framework of the one or more frameworks, wherein the target framework for the first operation is selected from the one or more frameworks based on the one or more ratings.

6. The system of claim 5, wherein the processing circuitry is further configured to receive one or more triggers, and wherein the processing circuitry identifies the one or more frameworks associated with the first operation in response to the one or more triggers.

7. The system of claim 6, wherein the one or more triggers correspond to at least one of a group consisting of a user input, a lapse of a periodic time interval, an update to at least one of the plurality of frameworks, or detection of a new framework.

8. The system of claim 5, wherein the target framework has the highest rating among the one or more frameworks.

9. The system of claim 5, wherein to generate a rating, of the one or more ratings, for each framework of the one or more frameworks, the processing circuitry is further configured to:
execute a plurality of measurement models on the set of performance metrics for the corresponding framework; and
generate a plurality of scores for the corresponding framework based on the execution of the plurality of measurement models on the set of performance metrics, wherein the rating is generated based on the plurality of scores.

10. The system of claim 9, wherein the rating generated for each framework of the one or more frameworks corresponds to an aggregation of the plurality of scores associated with the corresponding framework.

11. The system of claim 9, wherein the plurality of measurement models comprise at least two of a group consisting of a representation learning model, a deep Q-network model, or a policy gradient model.

12. The system of claim 1, wherein the set of functional characteristics of each framework of the plurality of frameworks corresponds to a set of operations supported by the corresponding framework.

13. The system of claim 1, further comprising a storage element, wherein the processing circuitry is coupled to the storage element, and configured to store a database including a mapping between the plurality of operations and the plurality of frameworks in the storage element.

14. The system of claim 1, further comprising a storage element, wherein the processing circuitry is coupled to the storage element, and configured to store a database including the translation instruction set for each framework of the plurality of frameworks.

15. The system of claim 1, wherein the processing circuitry is further configured to:
determine whether at least one framework of the plurality of frameworks is updated;
update, based on the determination that the at least one framework is updated, the plurality of features of the at least one framework; and
update the translation instruction set associated with the at least one framework based on the updated plurality of features.

16. The system of claim 15, wherein the update of the at least one framework corresponds to changes in a plurality of framework records associated with the at least one framework.

17. The system of claim 15, wherein the processing circuitry is further configured to update, based on the updated plurality of features, a rating associated with the at least one framework.

18. The system of claim 1, wherein the processing circuitry is further configured to:
identify, from the plurality of frameworks, one or more frameworks associated with the first operation, wherein at least one of the set of functional characteristics of each of the one or more frameworks matches the first operation;
generate one or more ratings for the one or more frameworks, respectively, wherein the target framework for the first operation is selected from the one or more frameworks based on the one or more ratings;
determine whether at least one framework of the one or more frameworks is updated;
update, based on the determination that the at least one framework is updated, a rating, of the one or more ratings, associated with the at least one framework;
determine whether the updated rating is higher than a rating associated with the target framework; and
map, based on the determination that the updated rating is higher than the rating associated with the target framework, the updated framework as the target framework for the first operation.

19. A method comprising:
determining, by processing circuitry, for each framework of a plurality of frameworks, a plurality of features comprising a syntax and a set of functional characteristics of the corresponding framework;
generating, by the processing circuitry, a translation instruction set for each framework of the plurality of frameworks based on the plurality of features of the corresponding framework; and
mapping, by the processing circuitry, the plurality of frameworks to a plurality of operations such that for a first operation, a target framework is mapped, wherein at least one of the set of functional characteristics of the target framework matches the first operation, and wherein based on the translation instruction set of the target framework, the first operation is translated from a predefined syntax to the syntax of the target framework.
